(19) United States
(12) Patent Application Publication
(10) Pub. No.: US 2008/0057946 A1
(43) Pub. Date: Mar. 6, 2008

(54) Mobile terminal

(75) Inventors: Hiroaki Sato, Kokubunji-shi (JP); Takashi Yamaguchi, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/633,386

(22) Filed: Dec. 1, 2006

(30) Foreign Application Priority Data
Sep. 6, 2006 (JP) 2006-241807

(51) Int. Cl. H04Q 7/20

(52) U.S. Cl. 455/425

(57) ABSTRACT

In reading display information from an IC card, a mobile terminal detachably mounted with an IC card storing display information and adapted to access a server via a communication network reads or receives information representing the language type of a character string contained in the display information stored in the IC card. The mobile terminal then determines, based on the read or received information representing the language type, whether a memory in the mobile terminal stores font data required to display the character string contained in the display information. If it is determined that the memory does not store the required font data, the mobile terminal accesses the server to acquire the required font data from the server.

### CROSS-REFERENCE TO RELATED APPLICATIONS

This application is based upon and claims the benefit of priority from prior Japanese Patent Application No. 2006-241807, field Sep. 6, 2006, the entire contents of which are incorporated herein by reference.

### BACKGROUND OF THE INVENTION

1. Field of the Invention

The present invention relates to a mobile terminal which sets the environment of the mobile terminal by using information stored in a subscriber identity module (SIM) or universal subscriber identity module (USIM) card.

2. Description of the Related Art

In recent years, a mobile terminal which can be mounted with an IC card such as a SIM or USIM card has prevailed. The SIM card is a small IC card which adopts the Global System for Mobile Communication (GSM) standard, and includes a storage unit having a flash memory and a central processor having a central processing unit (CPU). The USIM card is used in a mobile terminal which adopts the International Mobile Telecommunication (IMT)-2000 standard, such as a cellular phone which adopts the Wideband Code Division Multiple Access (W-CDMA) scheme. The SIM and USIM cards are compatible with each other.

The storage unit of the SIM or USIM card stores, as necessary information, information required to execute a mobile communication protocol and various kinds of user information. The information required to execute the mobile communication protocol contains, e.g., a mobile terminal identification number (International Mobile Subscriber Identity [IMSI]) used to control a mobile terminal in a radio section, its own telephone number, its own position information, and security information such as a password. The user information contains, e.g., charging information, a telephone book, and an outgoing/incoming history.

The SIM or USIM card has, as arbitrary functions, a function of calculating an authentication value in response to an authentication request from a mobile communication network, and an application program for electronic commerce transactions by using the Short Message Service (SMS). These functions are called SIM Application Toolkit (SAT) or USIM Application Toolkit (USAT).

A user has a plurality of SIM or USIM cards, and selectively inserts these cards into the mobile terminal. With this operation, for example, the user can properly use one mobile terminal for business and private uses. If a plurality of users hold the SIM or USIM cards of their own, these cards are selectively inserted into one mobile terminal. With this operation, for example, the plurality of users can share one mobile terminal (e.g., see Jpn. Pat. Appln. KOKAI Publication No. 2003-324768).

Upon insertion of the SIM or USIM card, the mobile terminal reads, from the card, the necessary information such as the information required to operate the mobile communication protocol and various kinds of user information, by using a command group called Generic Commands. The mobile terminal sets the operation environment of the mobile terminal based on the read necessary information. The mobile terminal then reads the menu information of a USAT function from the card, and displays it on a display device, by using a command group called USAT Commands. When the user selects a desired function from the displayed menu information, the mobile terminal reads, from the card, an application program corresponding to the selected function, and sets the operation environment of the mobile terminal.

However, the SIM or USIM cards are issued in many countries. Hence, the menu information representing an arbitrary function such as the USAT function of various kinds of information stored in the card is not always described in a major language such as English or Japanese. Even upon reading, from the SIM or USIM card, the menu information representing the USAT function, the mobile terminal cannot display all the read menu information if the mobile terminal stores only font data for displaying major languages.

### BRIEF SUMMARY OF THE INVENTION

It is an object of the present invention to provide a mobile terminal which can accurately display menu information even when the menu information representing a USAT function stored in an IC card is described in any language.

From one aspect of the present invention, in reading display information from an IC card, a mobile terminal detachably mounted with the IC card storing the display information and adapted to access a server via a communication network reads or receives information representing the language type of a character string contained in the display information stored in the IC card. The mobile terminal then determines, based on the read or received information representing the language type, whether a memory in the mobile terminal stores font data required to display the character string contained in the display information. If it is determined that the memory does not store the required font data, the mobile terminal accesses the server to acquire the required font data from the server.

### BRIEF DESCRIPTION OF THE SEVERAL VIEWS OF THE DRAWING

FIG. 1 is a block diagram showing the arrangement of a mobile terminal according to an embodiment of the present invention; and

FIG. 2 is a view showing an operation sequence between the mobile terminal shown in FIG. 1 and a USIM card, and the control content of the mobile terminal.

### DETAILED DESCRIPTION OF THE INVENTION

An embodiment of the present invention will be described hereinafter with reference to the accompanying drawings.

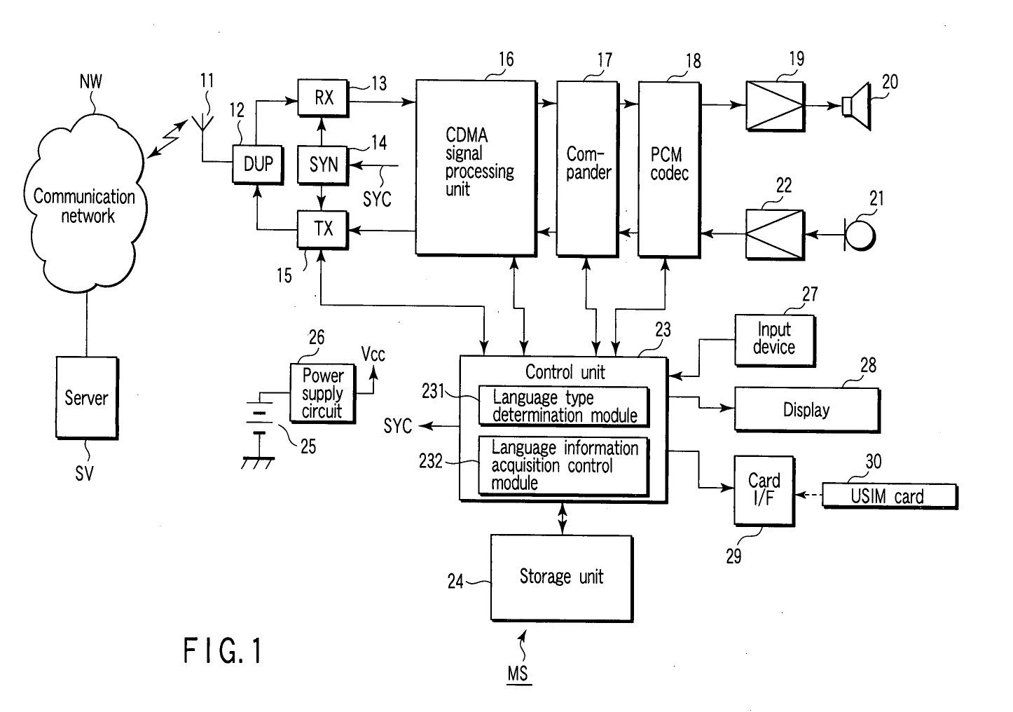

FIG. 1 is a block diagram showing the arrangement of a mobile terminal MS and a network side equipment according to an embodiment of the present invention. In FIG. 1, a radio signal transmitted from a mobile communication base station (not shown) in a communication network NW is received by an antenna 11, and is input to a reception circuit (RX) 13 via an antenna duplexer (DUP) 12. The reception circuit 13 down-converts the reception radio signal to an intermediate-frequency signal by mixing it with a local oscillation signal output from a frequency synthesizer (SYN) 14. The circuit 13 then quadrature-demodulates this down-converted intermediate-frequency signal to output a received baseband signal. Note that the frequency of the local oscillation signal generated by the frequency synthesizer 14 is designated by a control signal SYC output from a control unit 23.

The received baseband signal is input to a CDMA signal processing unit 16. The CDMA signal processing unit 16 comprises a RAKE receiver. The RAKE receiver despreads a plurality of paths included in the received baseband signal by spreading codes. The despread path signals are combined after their phases are arbitrated. As a result, reception packet data of a predetermined transmission format is obtained. The reception packet data is input to a compression/expansion processing unit (referred to as a compander hereinafter) 17.

First, the compander 17 demultiplexes the reception packet data output from the CDMA signal processing unit 16 for respective media. The compander 17 applies a decoding process for each demultiplexed media data. For example, when the reception packet data includes audio data, the compander 17 decodes this audio data by a speech codec. On the other hand, when the reception packet data includes video data, the compander 17 decodes this video data by a video codec.

A digital audio signal obtained by this decoding process is input to a PCM code processing unit (referred to as a PCM codec hereinafter) 18. The PCM codec 18 PCM-decodes the digital audio signal output from the compander 17 and outputs an analog audio signal. This analog audio signal is amplified by an incoming speech amplifier 19, and is then output from a loudspeaker 20.

The digital video signal decoded by the video codec of the compander 17 is input to the control unit 23. The control unit 23 displays the digital video signal output from the compander 17 on a display 28 using a video RAM (not shown). Note that the control unit 23 displays not only the received video data but also video data obtained by a camera (not shown) on the display 28 using the video RAM.

When the reception packet data includes text data such as an E-mail message, application program, or the like, the compander 17 outputs this text data to the control unit 23. The control unit 23 stores the text data such as the E-mail message or application in a storage unit 24. The control unit 23 reads the text data from the storage unit 24, and displays it on the display 28 in accordance with a display operation performed by the user using an input device 27.

An audio signal of a speaker input to a microphone 21 is amplified to a level required for coding processing by an outgoing speech amplifier 22. The amplified audio signal undergoes a PCM coding process by the PCM codec 18 to be converted into a digital audio signal, which is input to the compander 17. Also, a video signal output from the camera (not shown) is converted into a digital signal by the control unit 23, and is input to the compander 17. Note that the text data such as an E-mail message, which is created by the control unit 23, and various kinds of request data created by a browser are also input from the control unit 23 to the compander 17.

The compander 17 detects the amount of energy of input speech from the digital audio signal output from the PCM codec 18, and determines a transmission data rate based on this detection result. The compander 17 encodes the digital audio signal to a signal of a format corresponding to the transmission data rate, thereby generating audio data. Also, the compander 17 encodes the digital video signal output from the control unit 23 to generate video data. The compander 17 packetizes these audio and video data according to a predetermined transmission format, and outputs transmission packet data to the CDMA signal processing unit 16. When text data such as an E-mail message or the like is output from the control unit 23, it is also multiplexed on the transmission packet data.

The CDMA signal processing unit 16 applies a spread spectrum process to the transmission packet data output from the compander 17 using spread codes assigned to a transmission channel. Then, the unit 16 outputs that output signal to a transmission circuit (TX) 15. The transmission circuit 15 modulates the spread spectrum signal using a digital modulation scheme such as QPSK or the like. The transmission circuit 15 up-converts the transmission signal generated by this modulation process into a radio signal by mixing it with a local oscillation signal generated by the frequency synthesizer 14. The transmission circuit 15 then amplifies the radio signal to a transmission power level designated by the control unit 23. The amplified radio signal is supplied to the antenna 11 via the antenna duplexer 12, and is transmitted from the antenna 11 to the mobile communication base station.

Not that reference numeral 26 denotes a power supply circuit which generates a predetermined operation power supply voltage Vcc based on an output voltage from a battery 25, and supplies it to each circuit. A charging circuit (not shown) charges the battery 25.

Note that the mobile terminal MS has a card interface 29. The card interface 29 is detachably mounted with a USIM card 30. As described above, the USIM card 30 stores necessary information including information required to operate a mobile communication protocol and various kinds of user information, and the information of a USAT function such as the application and control data of the USAT function.

The storage unit 24 comprises, e.g., a NAND type flash memory. The storage unit 24 has a program storage area, control data storage area, and user data storage area. The program storage area stores an application program for causing the control unit 23 to execute various kinds of control processes. The control data storage area stores mobile terminal identification number, subscriber information, terminal position information, security information such as a password, font data for displaying data, and the like read from the USIM card 30, in addition to various kinds of control data generated in the mobile terminal MS. The user data storage area stores telephone book data, outgoing/incoming history data, and the like read from the USIM card 30, in addition to user data such as E-mail messages and photographs transmitted/received by the mobile terminal MS.

For example, the control unit 23 has a microcomputer as a main control unit, which includes a language type determination module 231 and language information acquisition control module 232 as the main control functions of the present invention.

When reading the menu information of the USAT function from the USIM card 30 using USAT Commands, the language type determination module 231 acquires information (Language Notification) which represents the type of language used, from the USIM card 30. The language type determination module 231 compares the acquired type of language used with the type of language corresponding to the font data capable of being displayed by the mobile terminal MS, and then determines whether the language type used in the menu of the USIM card 30 coincides with the language type of the font data of the mobile terminal MS.

If the language type determination module 231 determines that the language type used in the menu of the USIM card 30 does not coincide with the language type of the font data of the mobile terminal, the language information acquisition control module 232 accesses a server SV via the communication network NW. After that, the language information acquisition control module 232 downloads, from the server SV, the font data corresponding to the language used to describe the menu.

For downloading the font data, the language information acquisition control module 232 has a function of selecting a server operated by the carrier which issues the USIM card, based on the mobile terminal identification number (IMSI) read from the USIM card 30. The language information acquisition control module 232 also has a function of attempting to acquire the font data up to a predetermined maximum number of times every predetermined timing when the language information acquisition control module 232 fails to access the server SV or download the font data due to the influence of a radio quality or the like.

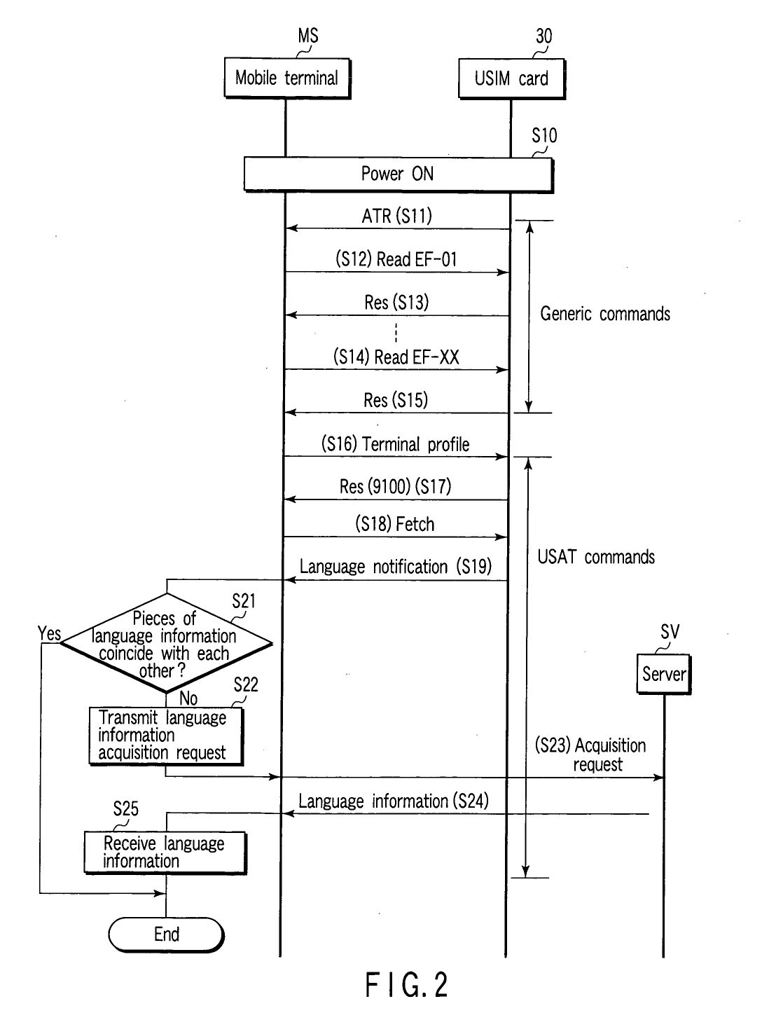

The operation of the mobile terminal MS having such an arrangement will be described below. FIG. 2 is a view showing an operation sequence between the mobile terminal MS and the USIM card 30, and the control content of the mobile terminal MS.

A user inserts his/her own USIM card 30 into the card interface 29 of the mobile terminal MS to be used. In this state, the mobile terminal MS is powered on in step S10. The power supply voltage Vcc is supplied to each circuit in the terminal from the power supply circuit 26 of the mobile terminal MS, and to the USIM card 30 via the card interface 29.

In an operating state, the mobile terminal MS reads the necessary information from the USIM card 30 using Generic Commands as follows. That is, upon power on, as shown in FIG. 2, the USIM card 30 transmits information ATR representing the basic capability of the USIM card 30 to the mobile terminal MS (step S11). The information representing the basic capability includes, e.g., information representing a data transfer bit rate and data transfer protocol. The control unit 23 of the mobile terminal MS recognizes the basic capability of the USIM card 30 based on the information ATR representing the basic capability transmitted from the USIM card 30.

After recognizing the basic capability, the control unit 23 of the mobile terminal MS transmits a read request Read EF_xx to the USIM card 30 for each information element in order to read the necessary information from the USIM card 30. For example, when there are ten information elements, the control unit 23 sequentially transmits read requests Read EF_01 to Read EF_10 to the USIM card 30 (steps S12 to S14). Upon reception of each of the read requests Read EF_01 to Read EF_10, the USIM card 30 transmits response data Res to the mobile terminal MS (steps S13 to S15). Accordingly, the mobile terminal MS reads the necessary information from the USIM card 30 using Generic Commands.

The control unit 23 then reads the arbitrary information using USAT Commands as follows. That is, first, the control unit 23 notifies the USIM card 30 of information Terminal Profile representing the support capability of USAT Commands in the mobile terminal MS (step S16). Upon reception of Terminal Profile, the USIM card 30 sends back a response Res(9100) (step S17). The control unit 23 then transmits a command Fetch to the USIM card 30 in order to inquire the type of language used (step S18). In response to this inquiry, the USIM card 30 sends back, to the mobile terminal MS, the information Language Notification representing the type of language used (step S19).

Upon reception of the information Language Notification representing the type of language used, the control unit 23 of the mobile terminal MS compares the received type of language used with the type of language corresponding to the font data capable of being displayed by the mobile terminal MS, in step S21. The control unit 23 also determines whether the language type used in the menu of the USIM card 30 coincides with the language type of the font data of the mobile terminal MS. Assume that, in accordance with this determination, one language of the font data of the mobile terminal MS coincides with the language used as a character string in the menu information stored in the USIM card 30. In this case, the control unit 23 ends the language information acquisition process.

On the other hand, assume that no language of the font data of the mobile terminal MS coincides with the language used as the character string in the menu stored in the USIM card 30. In this case, the process advances to step S22, and the control unit 23 of the mobile terminal MS acquires the language information.

For example, based on the mobile terminal identification number (IMSI) read from the USIM card 30 using Geneic Commands, the mobile terminal MS selects a server operated by the carrier which issues the USIM card 30. The mobile terminal MS accesses the selected server SV via the communication network NW to transmit a language information acquisition request (step S23). In response to the acquisition request from the mobile terminal MS, the server SV downloads the required language information, i.e., the font data (step S24). The control unit 23 of the mobile terminal MS receives the downloaded font data in step S25, and additionally stores it in the control data storage area in the storage unit 24.

When the font data storage area in the control data storage area has no free space, for example, the font data corresponding to the language which has not been used in the past or a predetermined language having a low priority order is erased to additionally store the new font data in place of the deleted font data.

When the mobile terminal MS fails to access the server SV or download the font data due to the influence of radio channel quality degradation between the mobile terminal MS and the server SV, the mobile terminal MS attempts to download the font data up to a predetermined maximum number of times every predetermined timing. Therefore, the mobile terminal MS can acquire font data corresponding to the required language even when the radio channel quality temporarily degrades.

Assume that the server SV has no font data corresponding to the required language. In this case, the control unit 23 of the mobile terminal MS selects a server as a second candidate, from the serves operated by a radio-accessing carrier, or predetermined servers to attempt to acquire the font data corresponding to the required language. With this operation, the control unit 23 can acquire the font data corresponding to the required language, more accurately.

Note that upon successfully acquiring the font data corresponding to the required language, the control unit 23 of the mobile terminal MS reads the menu information of the USAT function from the USIM card 30, and displays it on the display 28 using the above-described font data. Accordingly, the mobile terminal MS can display the menu information of the USAT function.

As described above, in this embodiment, in order to read the list (menu) of the USAT function from the USIM card 30, the mobile terminal MS acquires the information (Language Notification) representing the type of language used from the USIM card 30, compares the type of language used with the type of language corresponding to the font data capable of being displayed by the mobile terminal MS, and determines whether the language type used in the menu information of the USIM card 30 coincides with the language type of the font data of the mobile terminal MS. If it is determined that the language type used in the menu information of the USIM card 30 does not coincide with the language type of the font data of the mobile terminal, the mobile terminal MS acquires the font data corresponding to the language used in the menu from the server SV.

Therefore, even when the mobile terminal MS has no font data corresponding to the language which describes the display information such as the menu information stored in the USIM card 30, the font data corresponding to the appropriate language is downloaded from the server SV, and additionally stored in the storage unit 24 of the mobile terminal MS. Hence, the display 28 of the mobile terminal MS can accurately display the display information in any kinds of languages which is stored in the USIM card 30.

In acquiring the language information, the mobile terminal MS selects a server operated by the carrier which issues the USIM card 30, based on the mobile terminal identification number (IMSI) read from the USIM card 30 using Generic Commands. The mobile terminal MS accesses the selected server SV to acquire the language information. Hence, the mobile terminal MS can acquire the font data corresponding to the required language, more accurately.

When the mobile terminal MS fails to access the server SV or download the font data due to radio channel quality degradation between the mobile terminal MS and the server SV, the mobile terminal MS attempts to download the font data up to a predetermined maximum number of times every predetermined timing. Hence, the mobile terminal MS can acquire the font data corresponding to the required language even when the radio channel quality temporarily degrades.

Note that the present invention is not limited to the above-described embodiment. For example, in the embodiment, the mobile terminal MS determines whether the language types coincide with each other using USAT Commands and acquires the font data corresponding to the required language, after completely acquiring the necessary information using Generic Commands. However, the present invention is not limited to this. The mobile terminal MS may acquire the necessary information using Generic Commands after determining whether the language types coincide with each other using USAT Commands and acquiring the font data corresponding to the required language.

In this embodiment, the power-on signal of the mobile terminal MS triggers acquisition of the necessary information using Generic Commands, determination whether the language types coincide with each other using USAT Commands, and acquisition of the font data corresponding to the required language. However, the present invention is not limited to this. An arbitrary reset operation in the mobile terminal, insertion of the card into the mobile terminal, or the like may trigger the above-described processes.

Except for these, various modifications of the type and arrangement of the mobile terminal, and the procedure and content of the determination process of determining that the language types coincides with each other and the acquisition process of acquiring the font data corresponding to the required language may be made without departing from the spirit or scope of the general inventive concept.

Note that the present invention is not limited to the above embodiments, and can be variously modified and implemented without departing from the spirit and scope of the invention on the practical stage. Various inventions can be achieved by an appropriate combination of building components disclosed in the embodiment. For example, several building components may be omitted from all the building components described in the embodiment. Further, building components in different embodiments may be properly combined.

What is claimed is:

1. A mobile terminal detachably mounted with an IC card storing display information and adapted to access a server via a communication network, comprising:
a memory configured to store font data used to display the display information;
a module configured to read, from the IC card, information representing a language type of a character string contained in the display information stored in the IC card;
a determination module configured to determine, based on the read information representing the language type, whether the memory stores the font data required to display the character string contained in the display information; and
a communication module configured to access the server via the communication network to acquire the required font data from the server if the determination module determines that the memory does not store the required font data.

2. The terminal according to claim 1 wherein
when the communication module fails to receive the required font data, the communication module repeatedly accesses the server every predetermined timing until the communication module receives the font data.

3. The terminal according to claim 1 wherein
the communication module further comprises
a selection module configured to select, based on an individual identification code, the server corresponding to one of a carrier and a service provider who issues the IC card if the IC card stores the individual identification code for mobile communication,
a reception module configured to receive the required font data from the server by accessing the selected server via the communication network, and
a module configured to write the received font data into the memory.

4. The terminal according to claim 3 wherein
when the communication module fails to receive the required font data, the communication module repeatedly accesses the server every predetermined timing until the communication module receives the font data.

5. A mobile terminal detachably mounted with an IC card storing display information and adapted to access a server via a communication network, comprising:
a memory configured to store font data used to display the display information;
a reception module configured to receive, from the IC card, information representing a language type of a character string contained in the display information stored in the IC card;
a determination module configured to determine, based on the received information representing the language type, whether the memory stores the font data required to display the character string contained in the display information; and
a communication module configured to access the server via the communication network to acquire the required font data from the server if the determination module determines that the memory does not store the required font data.

6. The terminal according to claim 5 wherein
when the communication module fails to acquire the required font data, the communication module repeatedly accesses the server every predetermined timing until the communication module acquires the font data.

7. The terminal according to claim 5 wherein
the communication module further comprises
a selection module configured to select, based on an individual identification code, a server corresponding to one of a carrier and a service provider who issues the IC card if the IC card stores the individual identification code for mobile communication,
a module configured to receive the required font data from the server by accessing the selected server via the communication network, and
a module configured to write the received font data into the memory.

8. The terminal according to claim 7 wherein
when the communication module fails to acquire the required font data, the communication module repeatedly accesses the server every predetermined timing until the communication module acquires the font data.
